(19) United States
(12) Patent Application Publication
(10) Pub. No.: US 2013/0254185 A1
(43) Pub. Date: Sep. 26, 2013

(54) CONTENTS SEARCH SERVICE SYSTEM AND CONTENTS SEARCH SERVICE METHOD

(71) Applicant: SK PLANET CO., LTD., Seoul (KR)

(72) Inventor: Sang Ho CHAE, Seoul (KR)

(73) Assignee: SK PLANET CO., LTD., Seoul (KR)

(21) Appl. No.: 13/732,633

(22) Filed: Jan. 2, 2013

(30) Foreign Application Priority Data
Jul. 1, 2010 (KR) 10-2010-0063369

(51) Int. Cl. G06F 17/30

(52) U.S. Cl. CPC G06F 17/30483
USPC 707/722; 707/737

(57) ABSTRACT

Provided is a contents search service system and a contents search service method. In the contents search service system and the contents search service method, popularity based on the number of hits that each of the contents has not in a limited range of a specific portal service but in the entire Web environment is provided to a user and, in particular, the popularity of the content with respect to each of the reproducing periods and detailed information on the content are provided to the user so that a reliable and detailed contents search service may be provided to the user.

### TECHNICAL FIELD

The present invention relates to a contents search service system, and more particularly, to a contents search service system, a contents search service method, a contents search service providing server, and a service providing method of the contents search service providing server, which can provide the popularity based on the number of hits for each content, not in the limited range of single portal service but in the entire Web environment, to a contents search service user, and can provide the popularity in each reproducing period of the contents and detailed information to the user, so as to provide a highly reliable, detailed, and effective contents search service.

### BACKGROUND

Recently, in an environment where a video may be reproduced through various types of fixed or mobile terminals as well as personal computers (PC), users may obtain/reproduce video contents such as broadcasting contents, moving pictures, and user created contents (UCC) through various means anytime and anywhere.

Therefore, users are led to continuously desire more various kinds of video contents. Following this trend, currently, various kinds of and huge amounts of contents are supplied to the Web environments and users can search for obtain desired video contents in such Web environments and then reproduce them.

In such environments, users have come to desire the ability to rapidly and conveniently search for popular video contents among the various kinds of and huge amounts of video contents that spread in the Web environment.

In order to satisfy the desires of users as described above, a search method allows users to know the popularity of the video contents based on the number of hits of the contents, so that the user may effectively obtain the popular video contents that they desire.

However, in the above search method, since the popularity is provided based on the number of hits in limited range of single portal service, there are limitations in providing correct and reliable popularity. Also, since only the number of hits for contents have is considered, it is not possible to provide specific and detailed information such as information on reproducing period in video contents having particularly high popularity.

### SUMMARY

Accordingly, an embodiment of the present invention made to provide a reliable, detailed, and effective contents search service to a user with contents search service system and method thereof, which interlock a contents search service providing server with at least one contents providing server to include contents and manage hits information with respect to reproducing period for the contents, generate and manage, by the contents search service providing server, total hits information with respect to reproducing period based on the hits information with respect to reproducing period collected by interworking with the at least one contents providing server, request, by a terminal device, search for certain content, search for, by the contents search service providing server, the certain content requested by the terminal device from the at least one contents providing server through clustering, and provide, by the contents search service providing server, search result and the total hits information with respect to reproducing period for the certain content.

In addition, another embodiment of the present invention made to provide a reliable, detailed, and effective contents search service to a user through contents search service providing server and method thereof, which generate and manage total hits information with respect to reproducing period based on the hits information with respect to reproducing period for each of contents collected by interworking with at least one contents providing server, search for certain content requested by a terminal device from the at least one contents providing server through clustering, and provide search result and the total hits information with respect to reproducing period for the certain content.

In accordance with an embodiment of the present invention, there is provided a contents search service system, comprising: at least one contents providing server configured to include contents and manage hits information with respect to reproducing period for the contents; a terminal device configured to request a search for certain content; and a contents search service providing server configured to generate and manage total hits information with respect to reproducing period based on the hits information with respect to reproducing period collected by interworking with the at least one contents providing server, search for the certain content requested by the terminal device from the at least one contents providing server through clustering, and provide search result and the total hits information with respect to reproducing period for the certain content.

The at least one contents providing server may be configured to generate and manage the hits information with respect to reproducing period and contents information including at least one of meta information, additional comments information of reproducing period, or title information of reproducing period, and provide the hits information and the content information with the contents search service providing server.

In accordance with an embodiment of the present invention, there is provided a contents search service providing server, comprising: a hit number information managing unit configured to generate and manage total hits information with respect to reproducing period based on the hits information collected by interworking with at least one contents providing server, the at least one contents providing server including contents and managing the hits information with respect to reproducing period for each of the contents; and a search result providing unit configured to search for certain content requested by a terminal device from the at least one contents providing server through clustering, and provide search result and the total hits information with respect to reproducing period for the certain content.

The search result providing unit may be configured to provide the search result including at least one of information for certain contents providing server including the certain content and information related with the certain content in the certain contents providing server, and the total hits information of the certain content with the terminal device, so the terminal device can display the search result, and the total hits information with respect to each of reproducing periods in form of a popularity indication bar.

The hit number information managing unit may be configured to generate the total hits information by normalizing the hits information collected from the at least one contents providing server and summing up the normalized hits information, wherein the normalized hits information for each of the at least one contents providing server is generated by identifying the total number of the hits information, the number of the reproducing period and an average of the number of the hits information and normalizing the hits information using the average of the number of the hits information.

The contents search service providing server may further comprise a period content information managing unit configured to generate and manage a period content information based on contents information including at least one of meta information, additional comments information of reproducing period, or title information of reproducing period, which are acquired by interworking with the at least one contents providing server.

The search result providing unit may be configured to provide, when a specific reproducing period on the popularity indication bar displayed on the terminal device is selected, a period content information for the specific reproducing period to the terminal device, so as to display the period content information, wherein the period content information including at least one of story, additional comments information, or title information regarding the specific reproducing period.

The search result providing unit may be configured to further provide the period content information for the specific reproducing period along with the search result and the total hits information with the terminal device, so that the terminal device can display the period content information for the specific reproducing period along with the popularity indication bar.

The contents search service providing server may further comprise a content providing unit configured to, when the terminal device select a specific reproducing period of the certain content based on the search result, identify reproducing time of the specific reproducing period and provide the certain content with the terminal device in synchronization with the recognized reproducing time information when the certain content is stored in a content storage unit.

When the certain content is not stored in the content storage unit, the content providing unit may be configured to provide information for the certain contents providing server including the certain content and information related with the certain content with the terminal device, so that allow the terminal device to receive the certain content from the certain contents providing server including the certain content.

In accordance with an embodiment of the present invention, there is provided a contents search service method, comprising: interlocking a contents search service providing server with at least one contents providing server to include contents and manage hits information with respect to reproducing period for the contents; generating and managing, by the contents search service providing server, total hits information with respect to reproducing period based on the hits information with respect to reproducing period collected by interworking with the at least one contents providing server; requesting, by a terminal device, search for certain content; searching for, by the contents search service providing server, the certain content requested by the terminal device from the at least one contents providing server through clustering; and providing, by the contents search service providing server, search result and the total hits information with respect to reproducing period for the certain content.

In accordance with an embodiment of the present invention, there is provided a service providing method of a contents search service providing server, comprising: generating and managing total hits information with respect to reproducing period based on the hits information with respect to reproducing period for each of contents collected by interworking with at least one contents providing server; searching for certain content requested by a terminal device from the at least one contents providing server through clustering; and providing search result and the total hits information with respect to reproducing period for the certain content.

The step of providing search result and the total hits information may comprise providing the search result including at least one of information for certain contents providing server including the certain content and information related with the certain content in the certain contents providing server, and the total hits information of the certain content with the terminal device, so that the terminal device can display the search result, and the total hits information with respect to each of reproducing periods in form of a popularity indication bar.

The step of managing of the hit number information may comprise identifying the total number of the hits information, the number of reproducing period and an average of the number of the hits information for each of the hits information collected from the at least one contents providing server, and normalizing the hits information using the average of the number of the hits information; and generating the total hits information by summing up the normalized hits information with respect to each of reproducing period.

The service providing method of the contents search service providing server may further comprise generating and managing a period content information based on contents information including at least one of meta information, additional comments information of reproducing period, or title information of reproducing period, which are acquired by interworking with the at least one contents providing server.

The service providing method of the contents search service providing server may further comprise providing, when a specific reproducing period on the popularity indication bar displayed on the terminal device is selected, a period content information for the specific reproducing period to the terminal device, so as to display the period content information, the period content information including at least one of story, additional comments information, or title information regarding the specific reproducing period.

The step of providing search result and the total hits information may further comprised providing the period content information for the specific reproducing period along with the search result and the total hits information with the terminal device, so that the terminal device can display the period content information for the specific reproducing period along with the popularity indication bar.

The service providing method of the contents search service providing server may further comprise identifying, when the terminal device select a specific reproducing period of the certain content based on the search result, reproducing time of the specific reproducing period; and providing the certain content with the terminal device in synchronization with the recognized reproducing time information when the certain content is stored in a content storage unit.

The service providing method of the contents search service providing server may further comprise providing, when the certain content is not stored in the content storage unit, information for the certain contents providing server including the certain content and information related with the certain content with the terminal device, so that allow the terminal device to receive the certain content from the certain contents providing server including the certain content.

In the contents search service system and the contents search service method according to embodiments of the present invention, total hits information with respect to each of the reproducing periods for each of the contents is managed by the contents search service providing server through interworking with the contents providing servers in Web, and when it is requested by the terminal device to search for a certain content, the search result of the certain content and the total hits information with respect to reproducing periods of the certain content are provided to the terminal device, so that user of the terminal device may be given to the total hits number, which represents the popularity of each of the contents in each of the reproducing periods not in the limited range of one portal service but in the entire Web environment.

Therefore, in the contents search service system and the contents search service method according to embodiments of the present invention, the popularity of each of the contents in each of the reproducing periods not in the limited range of the specific portal service but in the entire Web environment is provided to a contents search service user, and detailed information such as the title, additional comments, and the story with respect to each of the reproducing periods is provided to the user so that reliable, detailed, and effective contents search service may be provided to the user.

### BRIEF DESCRIPTION OF THE DRAWINGS

The above and other objects, features and advantages of the present invention will be more apparent from the following detailed description taken in conjunction with the accompanying drawings, in which:

FIG. 1 is a control block diagram illustrating a contents search service system according to an embodiment of the present invention;

FIG. 2 is a control block diagram illustrating a contents search service providing server according to the embodiment of the present invention;

FIG. 3 is a flowchart illustrating a contents search service method according to the embodiment of the present invention; and

FIG. 4 is a flowchart illustrating a method of providing a service of the contents search service providing server according to the embodiment of the present invention.

### DETAILED DESCRIPTION OF THE EXEMPLARY EMBODIMENTS

Hereinafter, exemplary embodiments of the present invention will be described with reference to the accompanying drawings.

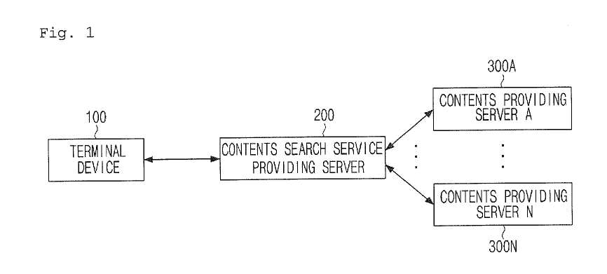

FIG. 1 is a view illustrating a contents search service system according to an embodiment of the present invention.

As illustrated in FIG. 1, the contents search service system according to the present invention includes contents providing servers 300A to 300N, each for including contents and managing hits information with respect to reproducing period for the contents, a terminal device 100 for requesting a search for certain content, and a contents search service providing server 200 for generating and managing total hits information with respect to reproducing period based on the hits information with respect to reproducing period collected by interworking with the at least one contents providing servers 300A to 300N, searching for the certain content requested by the terminal device 100 from the at least one contents providing server 300A to 300N through clustering, and providing search result and the total hits information with respect to reproducing period for the certain content to the terminal device 100.

The terminal device 100 is a reproducing apparatus for reproducing contents obtained by various methods. The terminal device 100 may include various apparatuses such as a mobile terminal, a personal digital assistant (PDA), a notebook, a personal computer (PC), and an Internet TV that may reproduce video contents such as broadcasting contents, video on demand (VOD) contents, or user created contents (UCC).

The terminal device 100 accesses the contents search service providing server 200 and provides a search word (for example, XX drama episode 3) input by a user to the contents search service providing server 200 to request the contents corresponding to the search word (for example, XX drama episode 3).

Each of the contents providing servers 300A to 300B manages hits information with respect to each of reproducing periods of contents included in the contents providing server.

The above will be described in detail with reference to the contents providing server 300A among the contents providing servers 300A to 300N. The contents providing server A 300A stores/possesses various contents registered by various users or contents providers and continuously monitors which content (for example, video content 1) is selected and reproduced by a predetermined user with respect to each of the various contents possessed by the contents providing server A 300A and which reproducing period (for example, reproducing periods 3 and 4) is reproduced among the previously set reproducing periods (for example, reproducing periods 1, 2, 3, 4, and 5) of a corresponding content (for example, the video content 1) when the corresponding content is selected and reproduced to generate and manage hits information with respect to each of reproducing periods for each of the contents.

The contents providing server A 300A may generate and manage content information including at least one of meta information of the corresponding content with respect to each of the possessed contents, additional comment information on each of the previously set reproducing periods, and information on the title of each of the reproducing periods as well as hits information with respect to each of reproducing periods of each of contents included in the contents providing server A 300A.

That is, the contents providing server A 300A may manage meta information (for example, content identification information, content title information, total reproducing time information, information on reproducing time in each of the reproducing periods that represents the start of reproducing and the end of reproducing, genre information, theme information, character information, and story information) that is registered with respect to each of the various contents possessed by the contents providing server A 300A. In addition, the contents providing server A 300A may collect and store the additional comment information (for example, comments, reviews, and questions) and information on the title of a reproducing period (for example, the title of a reproducing period and the story of a reproducing period) that are registered in synchronization with a predetermined reproducing period (for example, reproducing period 2) with respect to the content (for example, the video content 1) selected and reproduced by a predetermined user among the contents possessed by the contents providing server A 300A or with respect to the content (for example, the video content 1) selected by a contents provider.

The contents providing server A 300A may manage the content information including the meta information of the corresponding content, information on additional comments in each of the reproducing periods, and information on the title of each of the reproducing periods with respect to each of the contents possessed by the contents providing server A 300A.

Each of the contents providing servers 300A to 300N may provide hits information with respect to each of reproducing periods of contents included in the contents providing server and information on each of the contents possessed by the contents providing server to the contents search service providing server 200 through inter-working with the contents search service providing server 200.

The contents search service providing server 200 collects at least one hits information with respect to each of reproducing periods for each of the contents possessed by each of the contents providing servers 300A to 300N through inter-working with each of the contents providing servers 300A to 300N in accordance with the generation of a periodic or predetermined event (for example, request performed by the terminal device 100 to search for a content) and generates and manages total hits information with respect to each of reproducing periods for the contents providing servers 300A to 300N based on the at least one hits information with respect to each of reproducing periods for each of the contents possessed by each of the contents providing servers 300A to 300N.

The contents search service providing server 200 searches for the content requested to be searched for through clustering in accordance with the contents search service providing server 200 inter-working with each of the contents providing servers 300A to 300N when it is requested by the terminal device 100 to search for the content and provides a search result and hits information with respect to each of reproducing periods of searched content to the terminal device 100.

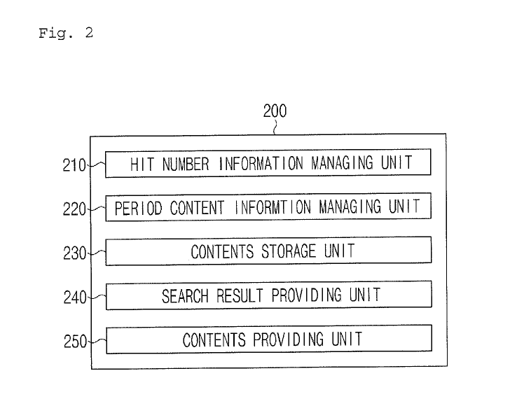

Hereinafter, the contents search service providing server 200 according to the present invention will be described in detail with reference to FIG. 2.

As illustrated in FIG. 2, the contents search service providing server 200 according to the present invention includes a hit number information managing unit 210 for generating and managing total hits information with respect to each of reproducing periods for the contents based on at least one hits information with respect to each of reproducing periods for each of the contents that is collected through inter-working with each of the contents providing servers 300A to 300N and a search result providing unit 240 for, when it is requested by the external terminal device 100 to search for a predetermined content, searching for the content requested to be searched for through clustering in accordance with the search result providing unit 240 inter-working with each of the contents providing servers 300A to 300N to provide a search result and the total hits information with respect to each of reproducing periods for the corresponding content to the terminal device 100.

The hit number information managing unit 210 collects the at least one hits information with respect to each of reproducing periods for each of the contents possessed by each of the contents providing servers 300A to 300N through inter-working with each of the contents providing servers 300A to 300N in accordance with the generation of the periodic or predetermined event (for example, the request performed by the terminal device 100 to search for a content) and generates and manages total hits information with respect to each of reproducing periods for each of the contents based on the at least one hits information with respect to each of reproducing periods for the contents possessed by each of the contents providing servers 300A to 300N.

That is, the hit number information managing unit 210 collects hits information with respect to each of reproducing periods of the contents possessed by each of the contents providing servers 300A to 300N from the contents providing servers 300A to 300N.

At this time, when the contents providing server A 300A and the contents providing server N 300N possess the same content (for example, the video content 1), the hit number information managing unit 210 collects hits information A for the corresponding content (for example, the video content 1) from the contents providing server A 300A and collects hits information N for the corresponding content (for example, the video content 1) from the contents providing server N 300N.

The hit number information managing unit 210 may collect only one hits information with respect to each of reproducing periods for certain content (for example, video content 3) and may collect various hits information with respect to each of reproducing periods (for example, hits information A, B, and N) for certain content (for example, the video content 1) with respect to each of the various contents possessed by each of the contents providing servers 300A to 300N.

The hit number information managing unit 210 generates and manages total hits information with respect to each of reproducing periods for the contents based on the at least one hits information with respect to each of reproducing periods that is collected by the hit number information managing unit 210 inter-working with each of the contents providing servers 300A to 300N as described above.

For example, when the only one hits information with respect to each of reproducing periods for a predetermined content (for example, the video content 3) is collected, the hit number information managing unit 210 may generate total hits information with respect to each of reproducing periods for the content (for example, the video content 3) by applying the only one hits information with respect to each of reproducing periods for the content (for example, the video content 3) as total hits information with respect to each of reproducing periods for the content (for example, the video content 3). In addition, when various hits information with respect to each of reproducing periods (for example, the hit number information items A, G, and N by each reproducing period) for a predetermined content (for example, the video content 1) are collected, the hit number information managing unit 210 may generate total hits information with respect to each of reproducing periods for the content (for example, the video content 1) by summing up hits information with respect to reproducing period for the content (for example, the video content 1) based on the various hits information with respect to each of reproducing periods (for example, the hit number information items A, G, and N by each reproducing period) for the content (for example, the video content 1).

It is assumed that hits information A for the content (for example, the video content 1) indicates that the number of hits is 4,000 in reproducing period 1, the number of hits is 2,000 in reproducing period 2, the number of hits is 1,000 in reproducing period 3, the number of hits is 5,000 in reproducing period 4, and the number of hits is 5,000 in reproducing period 5

Similarly, it is assumed that hits information B with respect to reproducing period for the content (for example, the video content 1) indicates that the number of hits is 40 in the reproducing period 1, the number of hits is 20 in the reproducing period 2, the number of hits is 50 in the reproducing period 3, the number of hits is 60 in the reproducing period 4, and the number of hits is 60 in the reproducing period 5, and it is assumed that hits information N with respect to reproducing period for the content (for example, the video content 1) indicates that the number of hits is 60 in the reproducing period 1, the number of hits is 80 in the reproducing period 2, the number of hits is 50 in the reproducing period 3, the number of hits is 140 in the reproducing period 4, and the number of hits is 240 in the reproducing period 5.

The hit number information managing unit 210 may sum up hits information with respect to each of reproducing periods to generate total hits information with respect to each of reproducing periods (the number of hits is 4,100 in the reproducing period 1, the number of hits is 2,100 in the reproducing period 2, the number of hits is 1,100 in the reproducing period 3, the number of hits is 5,200 in the reproducing period 4, and the number of hits is 5,300 in the reproducing period 5) for the corresponding content (for example, the video content 1).

At this time, when the number of users of a specific contents providing server (for example, the contents providing server A 300A) is remarkably larger than the number of users of the other servers so that the number of hits that the content has in the contents providing server A 300A is particularly high, it may be necessary to perform normalization in generating total hits information with respect to each of reproducing periods based on the at least one hits information with respect to each of reproducing periods that is collected from each of the contents providing servers 300A to 300N.

In generating total hits information with respect to each of reproducing periods based on the at least one hits information with respect to each of reproducing periods that is collected through inter-working with each of the contents providing servers 300A to 300N as described above, the hit number information managing unit 210 normalizes the at least one hits information with respect to each of reproducing periods and generates total hits information with respect to each of reproducing periods for a corresponding content by summing up hits information with respect to reproducing period based on the normalized at least one hits information with respect to each of reproducing periods.

For example, with respect to the at least one hits information with respect to each of reproducing periods (for example, the hits information items A, B, and N) for a predetermined content (for example, the video content 1), the hit number information managing unit 210 recognizes the entire hits, the number of reproducing periods, and the average number of hits from corresponding hits information with respect to each of reproducing periods of the content (for example, the video content 1) and normalizes the corresponding hits information based on the recognized average number of hits.

That is, when it is assumed that the hits information A with respect to each of reproducing periods for the content (for example, the video content 1) indicates that the number of hits is 4,000 in reproducing period 1, the number of hits is 2,000 in reproducing period 2, the number of hits is 1,000 in reproducing period 3, the number of hits is 5,000 in reproducing period 4, and the number of hits is 5,000 in reproducing period 5, the hit number information managing unit 210 may recognize that the entire hits are 17,000 (4,000+2,000+1,000+5,000+5,000), that the number of reproducing periods is 5, and that the average number of hits is 3,400 (17,000/5) from the hits information A for the content (for example, the video content 1) and may draw hits information A (the number of hits is 1.2 in the reproducing period 1, the number of hits is 0.6 in the reproducing period 2, the number of hits is 0.3 in the reproducing period 3, the number of hits is 1.5 in the reproducing period 4, and the number of hits is 1.5 in the reproducing period 5) (for example, rounding off the numbers to two decimal places) for the content (for example, the video content 1) normalized by dividing the corresponding hits information A for the content (for example, the video content 1) by the recognized average number of hits (3,400). In such a method, hits information B and N may be normalized.

With respect to the normalized information (for example, hits information A, B, and N) for the corresponding content (for example, the video content 1), the hit number information managing unit 210 may generate total hits information with respect to each of reproducing periods (the number of hits is X1 in the reproducing period 1, the number of hits is X2 in the reproducing period 2, the number of hits is X3 in the reproducing period 3, the number of hits is X4 in the reproducing period 4, and the number of hits is X5 in the reproducing period 5) for the corresponding content (for example, the video content 1) by summing up hits information with respect to reproducing period.

When it is requested by the terminal device 100 to search for the content corresponding to a predetermined search word (for example, XX drama episode 3), the search result providing unit 240 searches the content (for example, the XX drama episode 3—the video content 1) requested to be searched for through clustering in accordance with the search result providing unit 240 inter-working with each of the contents providing servers 300A to 300N and provides the search result and total hits information with respect to each of reproducing periods for the corresponding content (for example, the XX drama episode 3—the video content 1) to the terminal device 100. Here, since a conventional clustering method may be adopted as a method of searching for content on the Web through clustering, a detailed description thereof will be omitted.

That is, the search result providing unit 240 provides a search result, including at least one of contents providing server related information of a corresponding contents providing server that provides/possesses the content (for example, the XX drama episode 3—the video content 1) searched for in accordance with the search request of the terminal device 100 and contents related information of corresponding contents published in a corresponding contents providing server, and total hits information with respect to each of reproducing periods for the corresponding content (for example, the XX drama episode 3—the video content 1), which is managed by the hit number information managing unit 210, to the terminal device 100, so that the terminal device 100 displays the search result and displays a popularity indication bar by which it is possible to identify the total number of hits of the corresponding content (for example, the XX drama episode 3—the video content 1) with respect to each of the reproducing periods.

When the contents providing server A 300A and the contents providing server N 300N provide/possess the searched content (for example, the XX drama episode 3—the video content 1), the contents providing server related information may include service name information, access address information, and image information representing a corresponding server of the contents providing server A 300A and the contents providing server N 300N.

The contents related information may include storage position information, content identification information, content title information, and thumbnail information of the corresponding content (for example, the XX drama episode 3—the video content 1) in a corresponding contents providing server (for example, the contents providing servers 300A and 300N).

When the search result and total hits information with respect to each of reproducing periods are provided from the contents search service providing server and, in particular, the search result providing unit 240 in accordance with the search request, the terminal device 100 displays the contents providing server which provides and possesses the corresponding content (for example, the XX drama episode 3—the video content 1) in accordance with the search result, and displays the popularity indication bar, by which it is possible to identify the total number of hits that the corresponding content (for example, the XX drama episode 3—the video content 1) with respect to each of the reproducing periods, in accordance with the total hits information with respect to each of reproducing periods for the corresponding content (for example, the XX drama episode 3—the video content 1). At this time, in the popularity indication bar, different display colors are assigned in accordance with the range of the previously set total number of hits so that each of the reproducing periods has a display color in accordance with the range to which the corresponding total number of hits belongs. Here, the display color assigned in accordance with the range of the total number of hits is darker as the total number of hits is larger, that is, the popularity is higher and is lighter as the total number of hits is smaller, that is, the popularity is lower.

Therefore, the user of the terminal device 100 recognizes the contents providing servers that provide and possess the content (for example, the XX drama episode 3—the video content 1) requested to be searched for and, in particular, may check the popularity of the corresponding content (for example, the XX drama episode 3—the video content 1) on reproducing period basis at a look.

On the other hand, the contents search service providing server 200 according to the present invention may further include a period content information managing unit 220.

The period content information managing unit 220 generates and manages information on each of the contents with respect to each of the reproducing periods based on at least one information item on each of the contents including at least one of meta information of each of the contents that is collected through inter-working with each of the contents providing servers 300A to 300N, additional comment information, and information on the title with respect to each of the reproducing periods.

That is, the period content information managing unit 220 collects at least one information item on each of the contents possessed by each of the contents providing servers 300A to 300N through inter-working with each of the contents providing servers 300A to 300N in accordance with the generation of a periodic or predetermined event (for example, the request performed by the terminal device 100 to search for a content) and generates and manages the information on each of the contents with respect to each of the reproducing periods.

For example, the period content information managing unit 220 collects information on each of the contents possessed by each of the contents providing servers 300A to 300N from each of the contents providing servers 300A to 300N. Here, the content information includes meta information (for example, content identification information, content title information, total reproducing time information, information on reproducing time with respect to each of the reproducing periods that represents the start of reproducing and the end of reproducing, genre information, theme information, character information, and story information) of the corresponding content (for example, the video content 1) and additional comment information (for example, comments, reviews, and questions) with respect to each of the reproducing periods of the corresponding content (for example, the video content 1), and information on the title of each of the reproducing periods (for example, the title of a reproducing period and the story of a reproducing period) as described above when the contents providing servers 300A to 300N are described.

At this time, when the contents providing server A 300A and the contents providing server N 300N possess the same content (for example, the video content 1), the period content information managing unit 220 collects information A on the corresponding content (for example, the video content 1) from the contents providing server A 300A and collects information N on the corresponding content (for example, the video content 1) from the contents providing server N 300N.

The period content information managing unit 220 may collect the only one information item on a certain content (for the video content 3) and may collect various information items (for example, the content information items A, B, and N) on a certain content (for example, the video content 1) with respect to each of the various contents possessed by each of the contents providing servers 300A to 300N.

The period contents information managing unit 220 generates and manages the information on each of the contents with respect to each of the reproducing periods based on the information on each of the contents that is collected through inter-working with each of the contents providing servers 300A to 300N as described above.

For example, the period content information managing unit 220 may generate the information on each of the contents with respect to each of the reproducing periods including at least one of the title, the additional comments (for example, comments, reviews, and questions), and the story of a corresponding reproducing period (for example, the reproducing period 1) with respect to the reproducing periods (for example, the reproducing periods 1, 2, 3, 4, and 5) based on the information (for example, the meta information, the additional comment information with respect to each of the reproducing periods, and the information on the title of each of the reproducing periods) on the corresponding content (for example, the video content 3) when the only one content information item on a predetermined content (for example, the video content 3) is collected. In addition, the period content information managing unit 220 may generate the information on each of the contents with respect to each of the reproducing periods including at least one of the title, the additional comments (for example, comments, reviews, and questions), and the story of a corresponding reproducing period (for example, the reproducing period 1) with respect to the reproducing periods (for example, the reproducing periods 1, 2, 3, 4, and 5) based on the various content information items (for example, the content information items A, B, and N) when the various information items (for example, the content information items A, B, and N) on a predetermined content (for example, the video content 1) are collected.

On the other hand, as described above, a specific reproducing period (for example, the reproducing period 2) on the popularity indication bar may be indicated by the terminal device 100 which displays the search result and the popularity indication bar, by which it is possible to identify the total number of hits for the content (for example, the XX drama episode 3—the video content 1) with respect to each of the reproducing periods, based on the search result and the total hits information with respect to each of reproducing periods for the content (for example, the XX drama episode 3—the video content 1), which are provided in accordance with a search request for the content (for example, the XX drama episode 3—the video content 1).

When the specific reproducing period (for example, the reproducing period 2) on the popularity indication bar is indicated by the terminal device 100 displaying the popularity indication bar as described above, the search result providing unit 240 provides information on the content (for example, the video content 1) in the indicated specific reproducing period (for example, the reproducing period 2) from the information on the corresponding content (for example, the video content 1) with respect to each of the reproducing periods of the period content information managing unit 220 to the terminal device 100 so that the information on the content (for example, the video content 1) in the reproducing period (for example, the reproducing period 2) including at least one of the title, the additional comments, and the story of the corresponding reproducing period (for example, the reproducing period 2) is displayed.

Therefore, in the state where the terminal device 100 displays the contents providing server which to provides/possesses the corresponding content (for example, the XX drama episode 3—the video content 1) in accordance with the search result and displays the popularity indication bar by which it is possible to identify the total number of hits of the corresponding content (for example, the XX drama episode 3—the video content 1) in each of the reproducing periods, that is, the popularity of the content (for example, the XX drama episode 3—the video content 1) in each of the reproducing periods in accordance with total hits information with respect to each of reproducing periods for the content (for example, the XX drama episode 3—the video content 1), the user may indicate a specific reproducing period to conveniently identify the title of the specific reproducing period, the brief story of the specific reproducing period, and the additional comments of the other users in the specific reproducing period.

On the other hand, when the search result and the total hits information with respect to each of reproducing periods for the corresponding content (for example, the video content 1) are provided to the terminal device 100 in accordance with the request performed by the terminal device 100 to search for the content (for example, the XX drama episode 3—the video content 1), the search result providing unit 240 further provides the information on the corresponding content (for example, the video content 1) in each of the reproducing periods so that, when the terminal device 100 displays the search result and the popularity indication bar by which it is possible to identify the total number of hits of the content (for example, the video content 1) in each of the reproducing periods, the terminal device 100 may further display the information on the content (for example, the video content 1) with respect to each of the reproducing periods.

That is, when the search result providing unit 240 provides the search result and the total hits information with respect to each of reproducing periods for the corresponding content (for example, the video content 1) that are described above to the terminal device 100 in accordance with the request performed by the terminal device 100 to search for the content (for example, the XX drama episode 3—the video content 1), the search result providing unit 240 may further provide the information on the corresponding content (for example, the video content 1) in with respect to each of the reproducing periods that is managed by the period content information managing unit 220.

When the search result, the total hits information with respect to each of reproducing periods for the content (for example, the video content 1), and the information on the content (for example, the video content 1) in each of the reproducing periods are provided from the contents search service providing server and, in particular, the search result providing unit 240 in accordance with the search request, the terminal device 100 displays the contents providing server which provides and possesses the corresponding content (for example, the XX drama episode 3—the video content 1) in accordance with the search result, and displays the popularity indication bar, by which it is possible to identify the total number of hits of the corresponding content (for example, the XX drama episode 3—the video content 1) with respect to each of the reproducing periods, in accordance with the total hits information with respect to each of reproducing periods for the corresponding content (for example, the XX drama episode 3—the video content 1). Also, the terminal device 100 may display period contents information, which includes at least one of a period title, additional comments, and story of each of the reproducing periods of the corresponding content (for example, the XX drama episode 3—the video content 1) in accordance with the period contents information of each of the reproducing periods.

Therefore, the user of the terminal device 100 recognizes the contents providing servers that provide/possess the content (for example, the XX drama episode 3—the video content 1) requested to be searched for and, in particular, may conveniently check the popularity of the corresponding content (for example, the XX drama episode 3—the video content 1) in each of the reproducing periods, the title of each of the reproducing periods, the brief story of each of the reproducing period, and the additional comments of the other users in the corresponding reproducing period at a look.

Here, a progress bar representing the reproducing position of content may be commonly used as the above described popularity indication bar.

On the other hand, the contents search service providing server 200 according to the present invention further includes a contents storage unit 230 to store and manage the contents that may be provided by the contents search service providing server 200 in the contents storage unit 230 and the contents storage unit 230 or an additional functional unit (not shown) may generate and manage hits information with respect to each of reproducing periods of contents included in the contents storage unit 230 like each of the above described contents providing servers 300A to 300N.

In this case, when the hit number information managing unit 210 generates total hits information with respect to each of reproducing periods for each of the contents through inter-working with each of the contents providing servers 300A to 300N as described above, the hit number information managing unit 210 generates hits information with respect to each of reproducing periods based on hits information with respect to each of reproducing periods that is managed by the contents search service providing server 200 as well as hits information with respect to each of reproducing periods that is collected from each of the contents providing servers 300A to 300N.

The contents search service providing server 200 according to the present invention may further include a contents providing unit 250.

When a specific reproducing period (for example, the reproducing period 2) is selected to be reproduced with respect to the content (for example, the video content 1) published in a predetermined contents providing server (for example, the contents providing server A 300A) based on the search result displayed in the terminal device 100 as described above, the contents providing unit 250 recognizes the reproducing time information of the specific reproducing period (for example, the reproducing period 2) selected to be reproduced and, when the corresponding content (for example, the video content 1) exists in the contents storage unit 230, provides the corresponding content (for example, the video content 1) stored in the contents storage unit 230 to the terminal device 100 in synchronization with the recognized reproducing time information.

That is, when the specific reproducing period (for example, the reproducing period 2) is selected to be reproduced from the popularity indication bar with respect to the content (for example, the video content 1) published in a predetermined contents providing server (for example, the contents providing server A 300A) based on the search result displayed on the terminal device 100 as described above or when the information on the content (for example, the video content 1) in the specific reproducing period (for example, the reproducing period 2) is selected to be reproduced from the displayed information on the content (for example, the video content 1) in each of the reproducing periods, the contents providing unit 250 recognizes the reproducing time information (for example, reproducing starts at 10 minutes and ends at 20 minutes in the reproducing period 2) in accordance with the selection performed by the terminal device 100 to be reproduced and determines whether the corresponding content (for example, the video content 1) exists in the contents storage unit 230.

When the corresponding content (for example, the video content 1) exists in the contents storage unit 230, the contents providing unit 250 may provide the corresponding content (for example, the video content 1) stored in the contents storage unit 230 to the terminal device 100 in synchronization with the recognized reproducing time information (for example, reproducing starts at 10 minutes and 00 seconds and ends at 20 minutes and 00 seconds).

On the other hand, when the corresponding content (for example, the video content 1) does not exist in the contents storage unit 230, the contents providing unit 250 provides the contents providing server related information and the contents related information that are included in the search result (the result currently displayed on the terminal device 100) provided by the search result providing unit 240 to the terminal device 100 so that the terminal device 100 may receive the content (for example, the video content 1) of the specific reproducing period (for example, the reproducing period 2) selected to be reproduced from the corresponding contents providing server (for example, the contents providing server A 300A).

When the specific reproducing period (for example, the reproducing period 2) is selected by the terminal device 100 to be reproduced with respect to the content (for example, the video content 1) published in the specific contents providing server (for example, the contents providing server A 300A) based on the search result, the contents providing unit 250 does not immediately have the terminal device 100 connected to the corresponding contents providing server A 300A but, when the same content (for example, the video content 1) possessed by the contents search service providing server 200 exists, has the specific reproducing period (for example, the reproducing period 2) reproduced by the terminal device 100 with respect to the possessed content (for example, the video content 1).

In a state where the terminal device 100 displays the contents providing server which provides/possesses the corresponding content (for example, the XX drama episode 3—the video content 1) in accordance with the search result, and displays the popularity indication bar by which it is possible to identify the total number of hits of the corresponding content (for example, the XX drama episode 3—the video content 1) with respect to each of the reproducing periods, that is, the popularity of the corresponding content (for example, the XX drama episode 3—the video content 1) with respect to each of the reproducing periods in accordance with the total hits information with respect to each of reproducing periods for the corresponding content (for example, the XX drama episode 3—the video content 1), when a user selects a specific reproducing period (for example, reproducing period 2) of a content (for example, the video content 1) provided by the specific contents providing server to be reproduced, the user may easily reproduce/view the reproducing period 2 of the video content 1 selected to be reproduced.

As described above, the contents search service system according to the present invention manages total hits information with respect to each of reproducing periods for each of the contents through inter-working with all the contents providing servers 300A to 300N on the Web. Further, when it is requested by the terminal device 100 to search for certain content, the contents search service system according to the present invention provides hits information with respect to each of reproducing periods for the corresponding content to the terminal device 100 together with the search result of the corresponding content. As a result, the contents search service system can provide total hits information with respect to each of reproducing periods, that is, the popularity of each of the contents with respect to each of reproducing periods not in a limited range of a specific portal service but in the entire Web environment to the user of the terminal device 100.

That is, the contents search service system according to the present invention provides the popularity of each of the contents with respect to each of reproducing periods not in the limited range of the specific portal service but in the entire Web environment to the user of the contents search service and further provides detailed information such as the title of a corresponding reproducing period, the additional comments in the corresponding reproducing period, and the story of the corresponding reproducing period with respect to each of the reproducing periods to the user so that the contents search service system may provide a reliable, detailed, and effective contents search service to the user.

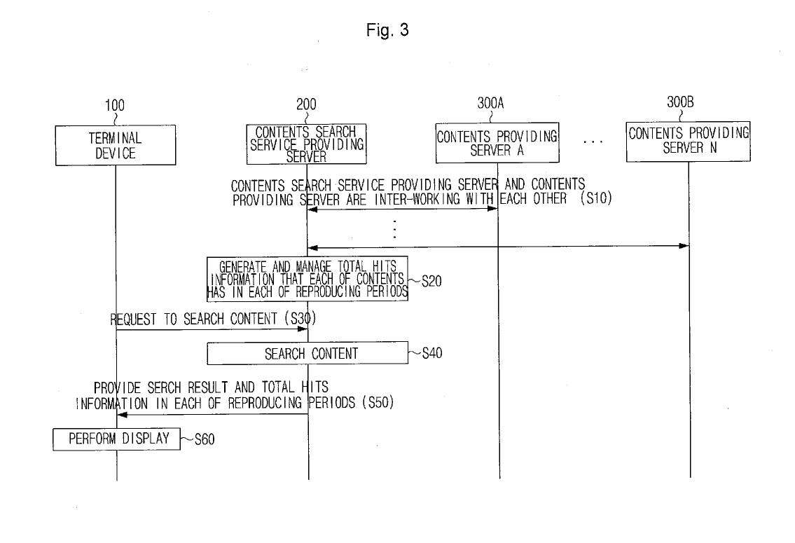

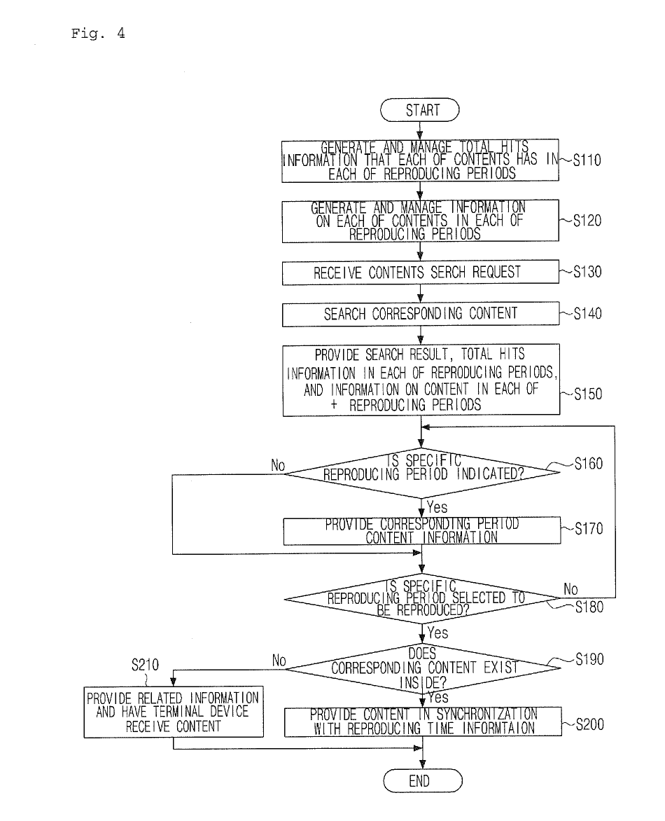

Hereinafter, a contents search service method according to the present invention will be described with reference to FIGS. 3 and 4. For convenience sake, description will be made by mentioning the reference numerals of FIGS. 1 and 2.

First, when the contents search service method according to the present invention is described with reference to FIG. 3, in the contents search service method according to the present invention, each of the contents providing servers 300A to 300N for managing hits information with respect to each of reproducing periods for each of the contents possessed by each of the contents providing servers 300A to 300N is inter-working with the contents search service providing server 200 (S10).

The contents search service providing server 200 generates and manages total hits information with respect to each of reproducing periods for each of the contents based on the at least one hits information with respect to each of reproducing periods that is collected from each of the contents providing servers 300A to 300N in S10 (S20).

The terminal device 100 provides the search word (for example, the XX drama episode 3) input by the user to the contents search service providing server 200 to request the contents search service providing server 200 to search the content corresponding to the search word (for example, the XX drama episode 3) (S30).

When it is requested by the terminal device 100 to search the content, the contents search service providing server 200 searches for the content (for example, the XX drama episode 3—the video content 1) requested by the terminal device 100 to be searched for through clustering in accordance with the contents search service providing server 200 inter-working with each of the contents providing servers 300A to 300N (S40).

The contents search service providing server 200 provides the search result of the search performed in S40 and the total hits information with respect to each of reproducing periods for the corresponding content to the terminal device 100 (S50).

The terminal device 100 displays the contents providing server which provides/possesses the corresponding content (for example, the XX drama episode 3—the video content 1) in accordance with the provided search result and displays (for example, in the form of the popularity indication bar) the total number of hits that the corresponding content (for example, the XX drama episode 3—the video content 1) to be identified in accordance with the total hits information with respect to each of reproducing periods for the corresponding content (for example, the XX drama episode 3—the video content 1). The user of the terminal device 100 recognizes the contents providing servers that provide/possess the content (for example, the XX drama episode 3—the video content 1) requested to be searched for and, in particular, may check the popularity of the corresponding content (for example, the XX drama episode 3—the video content 1) in reproducing period basis at a look.

Hereinafter, the service providing method of the contents search service providing server 200 according to the present invention will be described in detail with reference to FIG. 4.

In the service providing method of the contents search service providing server 200 according to the present invention, in accordance with the generation of a periodic or predetermined event (for example, the request performed by the terminal device 100 to search for the content), the at least one hits information with respect to each of reproducing periods for each of the contents providing servers 300A to 300N is collected by the contents search service providing server 200 inter-working with each of the contents providing servers 300A to 300N and the total hits information with respect to each of reproducing periods for each of the contents is generated and managed based on the at least one hits information with respect to each of reproducing periods (S110).

That is, in the service providing method of the contents search service providing server 200 according to the present invention, the contents search service providing server 200 collects the hits information with respect to each of reproducing periods for each of the contents possessed by each of the contents providing servers 300A to 300N.

At this time, when the contents providing server A 300A and the contents providing server N 300N possess the same content (for example, the video content 1), in the service providing method of the contents search service providing server 200 according to the present invention, the hits information A with respect to each of reproducing periods for the corresponding content (for example, the video content 1) is collected from the contents providing server A 300A and the hits information N with respect to each of reproducing periods for the corresponding content (for example, the video content 1) is collected from the contents providing server N 300N.

In the service providing method of the contents search service providing server 200 according to the present invention, with respect to each of the various contents possessed by each of the contents providing servers 300A to 300N, only one hits information with respect to each of reproducing periods for a certain content (for example, the video content 3) may be collected and various hits information with respect to each of reproducing periods (for example, hits information with respect to each of reproducing periods A, B, and N) for a certain content (for example, the video content 1) may be collected.

In the service providing method of the contents search service providing server 200 according to the present invention, as described above, the total hits information with respect to each of reproducing periods for each of the contents possessed by each of the contents providing servers 300A to 300N is generated and managed based on the at least one hits information with respect to each of reproducing periods for each of the contents possessed by each of the contents providing servers 300A to 300N.

For example, in the service providing method of the contents search service providing server 200 according to the present invention, when the only one hits information with respect to each of reproducing periods for a predetermined content (for example, the video content 3) is collected, the total hits information with respect to each of reproducing periods for the corresponding content (for example, the video content 3) may be generated by applying the only one hits information with respect to each of reproducing periods for the corresponding content (for example, the video content 3) as the total hits information with respect to each of reproducing periods for the corresponding content (for example, the video content 3). In addition, in the service providing method of the contents search service providing server 200 according to the present invention, when the various hits information with respect to each of reproducing periods (for example, the hits information with respect to each of reproducing periods A, B, and N) for predetermined content (for example, the video content 1) are collected, hits information with respect to reproducing period for the content (for example, the video content 1) are summed up based on the various hits information with respect to each of reproducing periods (for example, hits information with respect to each of reproducing periods A, B, and N) for the content (for example, the video content 1) to generate the total hits information with respect to each of reproducing periods for the content (for example, the video content 1).

At this time, when the number of users of a specific contents providing server (for example, the contents providing server A 300A) is remarkably larger than the number of users of the other servers so that the number of hits that the content has in the contents providing server A 300A is particularly high, it may be necessary to perform normalization in generating the total hits information with respect to each of reproducing periods for each of the contents based on the at least one hits information with respect to each of reproducing periods that is collected from each of the contents providing servers 300A to 300N.

In the service providing method of the contents search service providing server 200 according to the present invention, in performing 5110 of generating total hits information with respect to each of reproducing periods for each of the contents based on the at least one hits information with respect to each of reproducing periods that is collected through inter-working with each of the contents providing servers 300A to 300N as described above, the hit number information managing unit 210 normalizes the at least one hits information with respect to each of reproducing periods and generates total hits information with respect to each of reproducing periods for a corresponding content by summing up the number of hits based on the normalized at least one hits information with respect to each of reproducing periods.

For example, in the service providing method of the contents search service providing server 200 according to the present invention, with respect to the at least one hits information with respect to each of reproducing periods (for example, hits information with respect to each of reproducing periods A, B, and N) for a predetermined content (for example, the video content 1), the hit number information managing unit 210 recognizes the entire hits, the number of reproducing periods, and the average number of hits from corresponding hits information with respect to each of reproducing periods for the content (for example, the video content 1) and normalizes the corresponding hits information with respect to each of reproducing periods based on the recognized average number of hits.

That is, when it is assumed that the hits information A for the content (for example, the video content 1) indicates that the number of hits is 4,000 in reproducing period 1, that the number of hits is 2,000 in reproducing period 2, that the number of hits is 1,000 in reproducing period 3, that the number of hits is 5,000 in reproducing period 4, and that the number of hits is 5,000 in reproducing period 5, in the service providing method of the contents search service providing server 200 according to the present invention, the hit number information managing unit 210 may recognize that the entire hits are 17,000 (4,000+2,000+1,000+5,000+5,000), that the number of reproducing periods is 5, and that the average number of hits is 3,400 (17,000/5) from the hits information A for the content (for example, the video content 1) and may draw hits information A (indicating that the number of hits is 1.2 in the reproducing period 1, that the number of hits is 0.6 in the reproducing period 2, that the number of hits is 0.3 in the reproducing period 3, that the number of hits is 1.5 in the reproducing period 4, and that the number of hits is 1.5 in the reproducing period 5) (for example, rounding off the numbers to two decimal places) for the content (for example, the video content 1) normalized by dividing the corresponding hits information A by the recognized average number of hits (3,400). In such a method, hits information with respect to each of reproducing periods B and N may be normalized.

In the service providing method of the contents search service providing server 200 according to the present invention, with respect to the normalized information (for example, the hits information with respect to each of reproducing periods A, B, and N) for the corresponding content (for example, the video content 1), the hit number information managing unit 210 may generate total hits information with respect to each of reproducing periods (indicating that the number of hits is X1 in the reproducing period 1, that the number of hits is X2 in the reproducing period 2, that the number of hits is X3 in the reproducing period 3, that the number of hits is X4 in the reproducing period 4, and that the number of hits is X5 in the reproducing period 5) for the corresponding content (for example, the video content 1) by summing up hits information with respect to each of reproducing periods.

In the service providing method of the contents search service providing server 200 according to the present invention, in accordance with the generation of a periodic or predetermined event (for example, the request performed by the terminal device 100 to search for the content), the at least one information item on each of the contents possessed by each of the contents providing servers 300A to 300N is collected by the contents search service providing server 200 inter-working with each of the contents providing servers 300A to 300N and hits information with respect to each of reproducing periods for the contents possessed by each of the contents providing servers 300A to 300N is generated and managed based on the at least one information item on each of the contents (S120).

For example, in the service providing method of the contents search service providing server 200 according to the present invention, information on each of the contents possessed by each of the contents providing servers 300A to 300N is collected from each of the contents providing servers 300A to 300N. Here, the content information includes the meta information (for example, the content identification information, the content title information, the total reproducing time information, the information on reproducing time with respect to reproducing periods that represents the start of reproducing and the end of reproducing, the genre information, the theme information, the character information, and the story information) of the corresponding content (for example, the video content 1) and the additional comment information (for example, the comments, the reviews, and the questions) in each of the reproducing periods of the corresponding content (for example, the video content 1), and the information on the title of each of the reproducing periods (for example, the title of a reproducing period and the story of a reproducing period) as described above when the contents providing servers 300A to 300N are described.

At this time, when the contents providing server A 300A and the contents providing server N 300N possess the same content (for example, the video content 1), in the service providing method of the contents search service providing server 200 according to the present invention, information A on the corresponding content (for example, the video content 1) is collected from the contents providing server A 300A and information N on the corresponding content (for example, the video content 1) is collected from the contents providing server N 300N.

In the service providing method of the contents search service providing server 200 according to the present invention, with respect to each of the various contents possessed by each of the contents providing servers 300A to 300N, the only one information item on a certain content (for the video content 3) and various information items (for example, the content information items A, B, and N) on a certain content (for example, the video content 1) may be collected.

The information on each of the contents in each of the reproducing periods is generated and managed based on the information on each of the contents that is collected by the contents search service providing server 200 inter-working with each of the contents providing servers 300A to 300N.

For example, in the service providing method of the contents search service providing server 200 according to the present invention, when the only one content information item on a predetermined content (for example, the video content 3) is collected, the information on each of the contents in each of the reproducing periods including at least one of the title, the additional comments (for example, the comments, the reviews, and the questions), and the story of a corresponding reproducing period (for example, the reproducing period 1) with respect to the reproducing periods (for example, the reproducing periods 1, 2, 3, 4, and 5) may be generated based on the information (for example, the meta information, the additional comment information in each of the reproducing periods, and the information on the title of each of the reproducing periods) on the corresponding content (for example, the video content 3). In addition, in the service providing method of the contents search service providing server 200 according to the present invention, when the various information items (for example, the content information items A, B, and N) on a predetermined content (for example, the video content 1) are collected, the information on each of the contents in each of the reproducing periods including at least one of the title, the additional comments (for example, the comments, the reviews, and the questions), and the story of a corresponding reproducing period (for example, the reproducing period 1) with respect to the reproducing periods (for example, the reproducing periods 1, 2, 3, 4, and 5) may be generated based on the various content information items (for example, the content information items A, B, and N).

On the other hand, in the service providing method of the contents search service providing server 200 according to the present invention, when it is requested by the terminal device 100 to search for the content corresponding to the predetermined search word (for example, the XX drama episode 3) (S130), the content (for example, the XX drama episode 3—the video content 1) requested to be searched for is searched for through clustering in accordance with the contents search service providing server 200 inter-working with each of the contents providing servers 300A to 300N (S140). Here, since a conventional clustering method may be adopted as a method of searching for content on the Web through clustering, a detailed description thereof will be omitted.

In the service providing method of the contents search service providing server 200 according to the present invention, the search result of the search performed in S140 and total hits information with respect to each of reproducing periods for the corresponding content (for example, the XX drama episode 3—the video content 1) are provided to the terminal device 100 (S150).

That is, in the service providing method of the contents search service providing server 200 according to the present invention, the search result including at least one of information on a corresponding contents providing server that provides/possesses the content (for example, the XX drama episode 3—the video content 1) searched for in accordance with the search request of the terminal device 100 and information on corresponding contents published in a corresponding contents providing server, and the total hit number information on the number of hits of the corresponding content (for example, the XX drama episode 3—the video content 1) with respect to each of the reproducing periods, which is managed in step S110, are provided to the terminal device 100, so that the terminal device 100 displays the search result and displays a popularity indication bar by which it is possible to identify the total number of hits for the corresponding content (for example, the XX drama episode 3—the video content 1) in reproducing period basis.

When the contents providing server A 300A and the contents providing server N 300N provide/possess the searched content (for example, the XX drama episode 3—the video content 1), the contents providing server related information may include the service name information, the access address information, and the image information representing a corresponding server of the contents providing server A 300A and the contents providing server N 300N.

The contents related information may include the storage position information, the content identification information, the content title information, and the thumbnail information of the corresponding content (for example, the XX drama episode 3—the video content 1) in a corresponding contents providing server (for example, the contents providing servers 300A and 300N).

When the search result and total hits information with respect to each of reproducing periods are provided from the contents search service providing server 200 in accordance with the search request, the terminal device 100 displays the contents providing server which provides/possesses the corresponding content (for example, the XX drama episode 3—the video content 1) in accordance with the search result, and displays the popularity indication bar, by which it is possible to identify the total number of hits for the corresponding content (for example, the XX drama episode 3—the video content 1) in reproducing period basis, in accordance with total hits information with respect to each of reproducing periods for the corresponding content (for example, the XX drama episode 3—the video content 1). At this time, in the popularity indication bar, different display colors may be preferably assigned in accordance with the range of the previously set total number of hits so that each of the reproducing periods has a display color in accordance with the range to which the corresponding total number of hits belongs. Here, the display color assigned in accordance with the range of the total number of hits is preferably darker as the total number of hits is larger, that is, the popularity is higher and is preferably lighter as the total number of hits is smaller, that is, the popularity is lower.

Therefore, the user of the terminal device 100 recognizes the contents providing servers that provide/possess the content (for example, the XX drama episode 3—the video content 1) requested to be searched for and, in particular, may check the popularity of the corresponding content (for example, the XX drama episode 3—the video content 1) in reproducing period basis at a look.

On the other hand, in the service providing method of the contents search service providing server 200 according to the present invention, when the search result in accordance with the request performed by the terminal device 100 to search for the content (for example, the XX drama episode 3—the video content 1) and the total hits information with respect to each of reproducing periods for the corresponding content (for example, the video content 1) are provided to the terminal device 100 in step S150, the contents search service providing server 200 may further provide period contents information on the corresponding content (for example, video content 1) with respect to each of the reproducing periods to the terminal device 100, so as to further display the period contents information on the content (for example, the video content 1) with respect to each of the reproducing periods in the terminal device 100 when the search result and the popularity indication bar, by which it is possible to identify the total number of hits that the content (for example, the video content 1) with respect to each of the reproducing periods, are displayed in the terminal device 100.

That is, in the service providing method of the contents search service providing server 200 according to the present invention, in providing the search result and the total hits information with respect to each of reproducing periods for the corresponding content (for example, the video content 1) are provided to the terminal device 100 as described above in accordance with the request performed by the terminal device 100 to search for the content (for example, the XX drama episode 3—the video content 1), the information on the corresponding content (for example, the video content 1) with respect to each of the reproducing periods that is managed in S120 may be further provided to the terminal device 100.

When the search result, the total hits information with respect to each of reproducing periods for the content (for example, the video content 1), and the information on the content (for example, the video content 1) with respect to each of the reproducing periods have been provided from the contents search service providing server 200 in accordance with the search request, the terminal device 100 displays the contents providing server which provides/possesses the corresponding content (for example, the XX drama episode 3—the video content 1) in accordance with the search result, and displays the popularity indication bar, by which it is possible to identify the total number of hits for the corresponding content (for example, the XX drama episode 3—the video content 1) with respect to each of the reproducing periods, in accordance with total hits information with respect to each of reproducing periods for the corresponding content (for example, the XX drama episode 3—the video content 1). Further, the terminal device 100 may display the information on the corresponding content (for example, the XX drama episode 3—the video content 1) with respect to each of the reproducing periods, which includes at least one of period title, additional comments, and the story of each of the reproducing periods, in accordance with the information on the corresponding content (for example, the XX drama episode 3—the video content 1) with respect to each of the reproducing periods.

Therefore, the user of the terminal device 100 recognizes the contents providing servers that provide/possess the content (for example, the XX drama episode 3—the video content 1) requested to be searched for and, in particular, may conveniently check the popularity of the corresponding content (for example, the XX drama episode 3—the video content 1) with respect to each of the reproducing periods, the title of each of the reproducing periods, the brief story of each of the reproducing periods, and the additional comments of the other users in the corresponding reproducing period at a look.

On the other hand, as described above, a specific reproducing period (for example, the reproducing period 2) on the popularity indication bar may be indicated by the terminal device 100 which displays the search result and the popularity indication bar, by which it is possible to identify the total number of hits for the content (for example, the XX drama episode 3—the video content 1) with respect to each of the reproducing periods, based on the search result and the total hits information with respect to each of reproducing periods for the content (for example, the XX drama episode 3—the video content 1), which have been provided in accordance with the request to search for the content (for example, the XX drama episode 3—the video content 1).

Therefore, in the service providing method of the contents search service providing server 200 according to the present invention, the contents search service providing server 200 determines whether the specific reproducing period (for example, the reproducing period 2) on the popularity indication bar is indicated by the terminal device 100 (S160). Then, when the specific reproducing period (for example, the reproducing period 2) is indicated, the contents search service providing server 200 provides period contents information, which corresponds to an indicated specific reproducing period (for example, reproducing period 2) among the period contents information of each reproducing period managed in step S120 in accordance with the corresponding content (for example, the video content 1), to the terminal device 100 (S170), so as to display the period contents information, which includes at least one of the period title, additional comuents, and the story of the reproducing period (for example, the reproducing period 2).

Therefore, in the state where the terminal device 100 displays the contents providing server which provides/possesses the corresponding content (for example, the XX drama episode 3—the video content 1) in accordance with the search result, and displays the popularity indication bar, by which it is possible to identify the total number of hits for the corresponding content (for example, the XX drama episode 3—the video content 1) with respect to each of the reproducing periods, that is, the popularity of the content (for example, the XX drama episode 3—the video content 1) with respect to each of the reproducing periods, in accordance with the total hits information with respect to each of reproducing periods for the content (for example, the XX drama episode 3—the video content 1), the user may indicate a specific reproducing period to conveniently identify the title of the specific reproducing period, the brief story of the specific reproducing period, and additional comments of the other users in the specific reproducing period.

In the service providing method of the contents search service providing server 200 according to the present invention, when a specific reproducing period (for example, the reproducing period 2) is selected to be reproduced with respect to the content (for example, the video content 1) published in a predetermined contents providing server (for example, the contents providing server A 300A based on the search result displayed on the terminal device 100 as described above, the reproducing time information of the specific reproducing period (for example, the reproducing period 2) selected to be reproduced is recognized and, when the corresponding content (for example, the video content 1) stored in and possessed by the contents search service providing server 200 exists, the corresponding content (for example, the video content 1) stored in the contents search service providing server 200 is provided to the terminal device 100 in synchronization with the recognized reproducing time information.

That is, in the service providing method of the contents search service providing server 200 according to the present invention, based on the search result displayed in the terminal device 100 as described above, with respect to the content (for example, the video content 1) published in a predetermined contents providing server (for example, the contents providing server A 300A), it is determined whether the specific reproducing period (for example, the reproducing period 2) is selected to be reproduced from the popularity indication bar or whether the information on the content (for example, the video content 1) in the specific reproducing period (for example, the reproducing period 2) is selected to be reproduced from the displayed information on the content (for example, the reproducing period 2), so as to determine whether the specific reproducing period (for example, the reproducing period 2) is selected to be reproduced (S180).

When the specific reproducing period (for example, the reproducing period 2) is selected by the terminal device 100 to be reproduced, in the service providing method of the contents search service providing server 200 according to the present invention, the reproducing time information (for example, reproducing starts at 10 minutes and ends at 20 minutes in the reproducing period 2) in accordance with the selection performed by the terminal device 100 to be reproduced is recognized and it is determined whether the corresponding content (for example, the video content 1) stored in and possessed by the contents search service providing server 200 exists (S190).

When the corresponding content (for example, the video content 1) stored in the contents search service providing server 200 exists, in the service providing method of the contents search service providing server 200 according to the present invention, the corresponding content (for example, the video content 1) stored in the contents search service providing server 200 may be provided to the terminal device 100 in synchronization with the recognized reproducing time information (for example, reproducing starts at 10 minutes and 00 seconds and ends at 20 minutes and 00 seconds).

On the other hand, when the corresponding content (for example, the video content 1) stored in the contents search service providing server 200 does not exist, in the service providing method of the contents search service providing server 200 according to the present invention, the contents providing server related information and the contents related information that are included in the search result (the result currently displayed in the terminal device 100) provided to the terminal device 100 in 5150 are provided to the terminal device 100 so that the terminal device 100 may receive the content (for example, the video content 1) of the specific reproducing period (for example, the reproducing period 2) selected to be reproduced from the corresponding contents providing server (for example, the contents providing server A 300A) (S210).

In the service providing method of the contents search service providing server 200 according to the present invention, when the specific reproducing period (for example, the reproducing period 2) is selected by the terminal device 100 to be reproduced with respect to the content (for example, the video content 1) published in the specific contents providing server (for example, the contents providing server A 300A) based on the search result, the contents providing unit 250 does not immediately have the terminal device 100 connected to the corresponding contents providing server A 300A but, when the same content (for example, the video content 1) possessed by the contents search service providing server 200 exists, has the specific reproducing period (for example, the reproducing period 2) reproduced by the terminal device 100 with respect to the possessed content (for example, the video content 1).

In the state where the terminal device 100 displays the contents providing server which provides/possesses the corresponding content (for example, the XX drama episode 3—the video content 1) in accordance with the search result and displays the popularity indication bar, by which it is possible to identify the total number of hits of the corresponding content (for example, the XX drama episode 3—the video content 1) in each of the reproducing periods, that is, the popularity of the corresponding content (for example, the XX drama episode 3—the video content 1) in each of the reproducing periods, in accordance with total hits information with respect to each of reproducing periods for the corresponding content (for example, the XX drama episode 3—the video content 1), when the user selects the specific reproducing period (for example, the reproducing period 2) of the content (for example, the video content 1) provided by the specific contents providing server to be reproduced, the user may easily reproduce and view the reproducing period 2 of the video content 1 selected to be reproduced.

As described above, the contents search service method according to the present invention manages total hits information with respect to each of reproducing periods for each of the contents through inter-working with all the contents providing servers 300A to 300N on the Web. Further, when it is requested by the terminal device 100 to search for certain content, the contents search service method according to the present invention provides hits information with respect to each of reproducing periods for the corresponding content to the terminal device 100 together with the search result of the corresponding content. As a result, the contents search service system can provide the total number of hits for each of the contents with respect to each of the reproducing periods, that is, the popularity of each of the contents with respect to each of the reproducing periods not in a limited range of a specific portal service but in the entire Web environment to the user of the terminal device 100.

That is, in the contents search service method according to the present invention, the contents search service system according to the present invention provides the popularity of each of the contents in terms of each of the reproducing periods not in the limited range of the specific portal service but in the entire Web environment to the user of the contents search service and further provides detailed information such as the title of a corresponding reproducing period, the additional comments in the corresponding reproducing period, and the story of the corresponding reproducing period with respect to each of the reproducing periods to the user so that the contents search service system may provide a reliable, detailed, and effective contents search service to the user.

Although an exemplary embodiment of the present invention has been described for illustrative purposes, those skilled in the art will appreciate that various modifications, additions and substitutions are possible, without departing from the scope and spirit of the invention as disclosed in the accompanying claims.

When the contents search service system and the contents search service method, in which total hits information with respect to each of reproducing periods for each of the contents is managed by the contents search service providing server inter-working with each of the contents providing servers positioned on the Web, in which, when it is requested by the terminal device to search for a certain content, the search result of the corresponding content and the total hits information with respect to each of reproducing periods for the content are provided to the terminal device so that total number of hits for each of the contents with respect to each of the reproducing periods, that is, the popularity of each of the contents with respect to each of the reproducing periods not in the limited range of a specific portal service but in the entire Web environment may be provided to a user, and in which detailed information such as the title, the additional comments, and the story of a corresponding reproducing period with respect to each of the reproducing periods is provided to the user, are applied, it is possible to improve the efficiency, the reliability, and the satisfaction of the contents search service and to sell the applied contents search service providing server and service solution.

1. A contents search service system, comprising:
at least one contents providing server configured to collect and manage hits information with respect to a reproducing period for the contents;
a terminal device configured to request a search for certain content; and
a contents search service providing server configured to generate and manage total hits information with respect to the reproducing period based on the hits information with respect to the reproducing period collected by interworking with the at least one contents providing server, search for the certain content requested by the terminal device from the at least one contents providing server through clustering, and provide search result and the total hits information with respect to the reproducing period for the certain content.

2. The contents search service system as claimed in claim 1, wherein the at least one contents providing server is configured to generate and manage the hits information with respect to reproducing period and contents information including at least one of meta information, additional comments information of reproducing period, or title information of reproducing period, and provide the hits information and the content information with the contents search service providing server.

3. The contents search service providing server, comprising:
a hit number information managing unit configured to generate and manage total hits information with respect to reproducing period based on the hits information collected by interworking with at least one contents providing server, the at least one contents providing server including contents and managing the hits information with respect to reproducing period for each of the contents; and
a search result providing unit configured to search for certain content requested by a terminal device from the at least one contents providing server through clustering, and provide search result and the total hits information with respect to reproducing period for the certain content.

4. The contents search service providing server as claimed in claim 3, wherein the search result providing unit is configured to provide the search result including at least one of information for certain contents providing server including the certain content and information related with the certain content in the certain contents providing server, and the total hits information of the certain content with the terminal device, so the terminal device can display the search result, and the total hits information with respect to each of reproducing periods in form of a popularity indication bar.

5. The contents search service providing server as claimed in claim 3, wherein, the hit number information managing unit is configured to generate the total hits information by normalizing the hits information collected from the at least one contents providing server and summing up the normalized hits information, wherein the normalized hits information for each of the at least one contents providing server is generated by identifying the total number of the hits information, the number of the reproducing period and an average of the number of the hits information and normalizing the hits information using the average of the number of the hits information.

6. The contents search service providing server as claimed in claim 4, further comprising a period content information managing unit configured to generate and manage a period content information based on contents information including at least one of meta information, additional comments information of reproducing period, or title information of reproducing period, which are acquired by interworking with the at least one contents providing server.

7. The contents search service providing server as claimed in claim 6, wherein, the search result providing unit is configured to provide, when a specific reproducing period on the popularity indication bar displayed on the terminal device is selected, a period content information for the specific reproducing period to the terminal device, so as to display the period content information, wherein the period content information including at least one of story, additional comments information, or title information regarding the specific reproducing period.

8. The contents search service providing server as claimed in claim 6, wherein the search result providing unit is configured to further provide the period content information for the specific reproducing period along with the search result and the total hits information with the terminal device, so that the terminal device can display the period content information for the specific reproducing period along with the popularity indication bar.

9. The contents search service providing server as claimed in claim 4 further comprising a content providing unit configured to, when the terminal device select a specific reproducing period of the certain content based on the search result, identify reproducing time of the specific reproducing period and provide the certain content with the terminal device in synchronization with the recognized reproducing time information when the certain content is stored in a content storage unit.

10. The contents search service providing server as claimed in claim 9, wherein, when the certain content is not stored in the content storage unit, the content providing unit is configured to provide information for the certain contents providing server including the certain content and information related with the certain content with the terminal device, so that allow the terminal device to receive the certain content from the certain contents providing server including the certain content.

11. A contents search service method, comprising:
interlocking a contents search service providing server with at least one contents providing server to include contents and manage hits information with respect to reproducing period for the contents;
generating and managing, by the contents search service providing server, total hits information with respect to reproducing period based on the hits information with respect to reproducing period collected by interworking with the at least one contents providing server
requesting, by a terminal device, search for certain content;
searching for, by the contents search service providing server, the certain content requested by the terminal device from the at least one contents providing server through clustering; and
providing, by the contents search service providing server, search result and the total hits information with respect to reproducing period for the certain content.

12. A service providing method of a contents search service providing server, comprising:
generating and managing total hits information with respect to reproducing period based on the hits information with respect to reproducing period for each of contents collected by interworking with at least one contents providing server;
searching for certain content requested by a terminal device from the at least one contents providing server through clustering; and
providing search result and the total hits information with respect to reproducing period for the certain content.

13. The service providing method of the contents search service providing server as claimed in claim 12, wherein providing search result and the total hits information comprises:
providing the search result including at least one of information for certain contents providing server including the certain content and information related with the certain content in the certain contents providing server, and the total hits information of the certain content with the terminal device, so that the terminal device can display the search result, and the total hits information with respect to each of reproducing periods in form of a popularity indication bar.

14. The service providing method of the contents search service providing server, wherein managing of the hit number information comprises:
identifying the total number of the hits information, the number of reproducing period and an average of the number of the hits information for each of the hits information collected from the at least one contents providing server, and normalizing the hits information using the average of the number of the hits information; and
generating the total hits information by summing up the normalized hits information with respect to each of reproducing period.

15. The service providing method of the contents search service providing server as claimed in claim 13, further comprising:
generating and managing a period content information based on contents information including at least one of meta information, additional comments information of reproducing period, or title information of reproducing period, which are acquired by interworking with the at least one contents providing server.

16. The service providing method of the contents search service providing server as claimed in claim 15, further comprising:
providing, when a specific reproducing period on the popularity indication bar displayed on the terminal device is selected, a period content information for the specific reproducing period to the terminal device, so as to display the period content information, the period content information including at least one of story, additional comments information, or title information regarding the specific reproducing period.

17. The service providing method of the contents search service providing server as claimed in claim 15, wherein providing search result and the total hits information further comprising:
providing the period content information for the specific reproducing period along with the search result and the total hits information with the terminal device, so that the terminal device can display the period content information for the specific reproducing period along with the popularity indication bar.

18. The service providing method of the contents search service providing server as claimed in claim 13 further comprising:
identifying, when the terminal device select a specific reproducing period of the certain content based on the search result, reproducing time of the specific reproducing period; and
providing the certain content with the terminal device in synchronization with the recognized reproducing time information when the certain content is stored in a content storage unit.

19. The service providing method of the contents search service providing server as claimed in claim 18, further comprising:
providing, when the certain content is not stored in the content storage unit, information for the certain contents providing server including the certain content and information related with the certain content with the terminal device, so that allow the terminal device to receive the certain content from the certain contents providing server including the certain content.

20. The contents search service providing server as claimed in claim 4 wherein, the hit number information managing unit is configured to generate the total hits information by normalizing the hits information collected from the at least one contents providing server and summing up the normalized hits information, wherein the normalized hits information for each of the at least one contents providing server is generated by identifying the total number of the hits information, the number of the reproducing period and an average of the number of the hits information and normalizing the hits information using the average of the number of the hits information.

21. The contents search service providing server as claimed in claim 7 further comprising a content providing unit configured to, when the terminal device select a specific reproducing period of the certain content based on the search result, identify reproducing time of the specific reproducing period and provide the certain content with the terminal device in synchronization with the recognized reproducing time information when the certain content is stored in a content storage unit.

22. The contents search service providing server as claimed in claim 8 further comprising a content providing unit configured to, when the terminal device select a specific reproducing period of the certain content based on the search result, identify reproducing time of the specific reproducing period and provide the certain content with the terminal device in synchronization with the recognized reproducing time information when the certain content is stored in a content storage unit.

23. The service providing method of the contents search service providing server as claimed in claim 16 further comprising:
identifying, when the terminal device select a specific reproducing period of the certain content based on the search result, reproducing time of the specific reproducing period; and
providing the certain content with the terminal device in synchronization with the recognized reproducing time information when the certain content is stored in a content storage unit.

24. The service providing method of the contents search service providing server as claimed in claim 17 further comprising:
identifying, when the terminal device select a specific reproducing period of the certain content based on the search result, reproducing time of the specific reproducing period; and
providing the certain content with the terminal device in synchronization with the recognized reproducing time information when the certain content is stored in a content storage unit.
